(19) United States
(12) Patent Application Publication
(10) Pub. No.: US 2007/0056145 A1
(43) Pub. Date: Mar. 15, 2007

(54) CLAMPING DEVICE WITH CUT BAND SHIELD AND METHOD OF USING SAME

(76) Inventors: MATTHEW J. STILLINGS, CENTENNIAL, CO (US); DANIEL J. NELSON, DENVER, CO (US); ANDREW T. FORD, SOUTH YORKSHIRE (GB); TERESA J. ABBOTT, BRIGHTON, CO (US)

Correspondence Address: SHERIDAN ROSS PC, 1560 BROADWAY, SUITE 1200, DENVER, CO, 80202, US

(21) Appl. No.: 11/530,295

(22) Filed: Sep. 8, 2006

Related U.S. Application Data
(60) Provisional application No. 60/715,691, filed on Sep. 9, 2005.

(51) Int. Cl. F16L 33/00

(52) U.S. Cl. 24/20 R

(57) ABSTRACT

A protective guard for a clamping device includes structure for physically separating an end of a band portion of the clamping device from an object or body part that may come in contact with the end. The protective guard can include one or more moveable or statically positioned tabs for inhibiting contact of an object or body part with the end.

### CROSS REFERENCE TO RELATED APPLICATION

The present application claims the benefit of U.S. Provisional Patent Application No. 60/715,691 filed on Sep. 9, 2005, the content of which is incorporated herein by reference in its entirety.

### FIELD OF THE INVENTION

The present invention is relates to a clamping device, and more particularly, to cable tie comprising a band shield.

### BACKGROUND OF THE INVENTION

Cable ties are commonly used as a clamping device, and are typically used to wrap two or more objects together and/or bind objects together. For example, cable ties are often used to connect insulation to electrical wires, bind a plurality of cables together, etc. The present invention is an improvement in a cable tie such as shown in U.S. Pat. No. 4,896,402 (“the '402 patent”) entitled “Cable Tie,” the content of which is incorporated herein by reference in its entirety. The device disclosed in the '402 patent is a one-piece cable tie. It further includes a buckle having a slot through which the free end of the band section is inserted. When the band is fully tightened to constrain the intended object or objects, the tail or free end of the band is cut or sheared adjacent to the edge of the slot, often leaving a cut end that comprises a sharp edge and/or burrs. The cut end can thereafter damage surrounding objects, and/or can cause cuts and injuries to persons operating within close proximity to the cable tie, such as technicians or electricians handling and working with the electrical cables.

Referring now to FIG. 1, a clamping device 10 of the prior art is shown. The clamping device 10 includes a band 14 having a first end 18 and a second end 22. Connected to the second end 22 is securing mechanism or buckle 26. This example of a clamping device 10 of the prior art includes a first buckle section 30 that is coplanar with the second end 22 of the band 14. In addition, a slot 34 separates the first buckle section 30 from a second buckle section 38, where the first buckle section 30 and second buckle section 38 are vertically offset. The buckle 26 further includes a first longitudinal side 42 and a second longitudinal side 46, where these sides 42 and 46 are aligned substantially parallel with a longitudinal axis L-L of the clamping device 10 and band 14. For the clamping device 10 shown in FIG. 1, the sides 42 and 46 interconnect the first buckle section 30 to the second buckle section 38.

Referring now to FIG. 2, the clamping device 10 of FIG. 1 is shown being wrapped around the exterior surface S if insulation I that surrounds object O, where first end 18 of the band 14 has been inserted through slot 34 of the buckle 26. In FIG. 3, the band 14 has been tightened around the surface S of insulation I. In addition, a portion 50 of the band 14, including first end 18, has been cut, thereby leaving cut end 54 at the buckle 26. It is this cut end 54 that is addressed by the present invention. Accordingly, it would be advantageous to provide a feature for shielding the sharp edge and/or burrs of the cut end, wherein such feature is operatively associated with the clamping device.

### SUMMARY

The present invention addresses the need for a protective feature for a clamping device such as a cable tie by providing a shield for covering or otherwise protectively blocking sharp edges and/or burrs from objects and/or individuals coming into contact with an end of a band of the clamping device.

Various embodiments of the present invention are set forth in the attached figures and in the detailed description of the invention as provided herein and as embodied by the claims. It should be understood, however, that this Summary does not contain all of the aspects and embodiments of the present invention, is not meant to be limiting or restrictive in any manner, and that the invention as disclosed herein is and will be understood by those of ordinary skill in the art to encompass obvious improvements and modifications thereto.

Additional advantages of the present invention will become readily apparent from the following discussion, particularly when taken together with the accompanying drawings.

### BRIEF DESCRIPTION OF THE DRAWINGS

FIG. 1 is a perspective view of a clamping device of the prior art;

FIG. 2 is a cross-sectional view of an object showing application of the clamping device of FIG. 1;

FIG. 3 is a cross-sectional view of an object showing application of the clamping device of FIG. 1, wherein the clamping device has been tightened and a portion of the band cut leaving a cut end;

FIG. 4 is a partial perspective view of a clamping device in accordance with an embodiment of the present invention;

FIG. 5 is a cross-sectional view of the device shown in FIG. 4;

FIG. 6 is a cross-sectional view of a modified version of the embodiment shown in FIG. 5;

FIG. 7 is perspective view of the device shown in FIG. 6 after folding;

FIG. 8 is a perspective view of another embodiment of the present invention;

FIG. 9 is a cross-sectional view of the device shown in FIG. 8;

FIG. 10 is a perspective view of a modified version of the embodiment shown in FIG. 8;

FIG. 11 is a perspective view of another embodiment of the present invention;

FIG. 12 is a plan view of the device shown in FIG. 11;

FIG. 13 is a perspective view of the device shown in FIG. 11 in a folded position;

FIG. 14 is a perspective view of another embodiment of the present invention;

FIG. 15 is a perspective view of another embodiment of the present invention;

FIG. 16 is a perspective view of another embodiment of the present invention;

FIG. 17 is a perspective view of another embodiment of the present invention; and

FIG. 18 is a perspective view of another embodiment of the present invention. The drawings are not necessarily to scale.

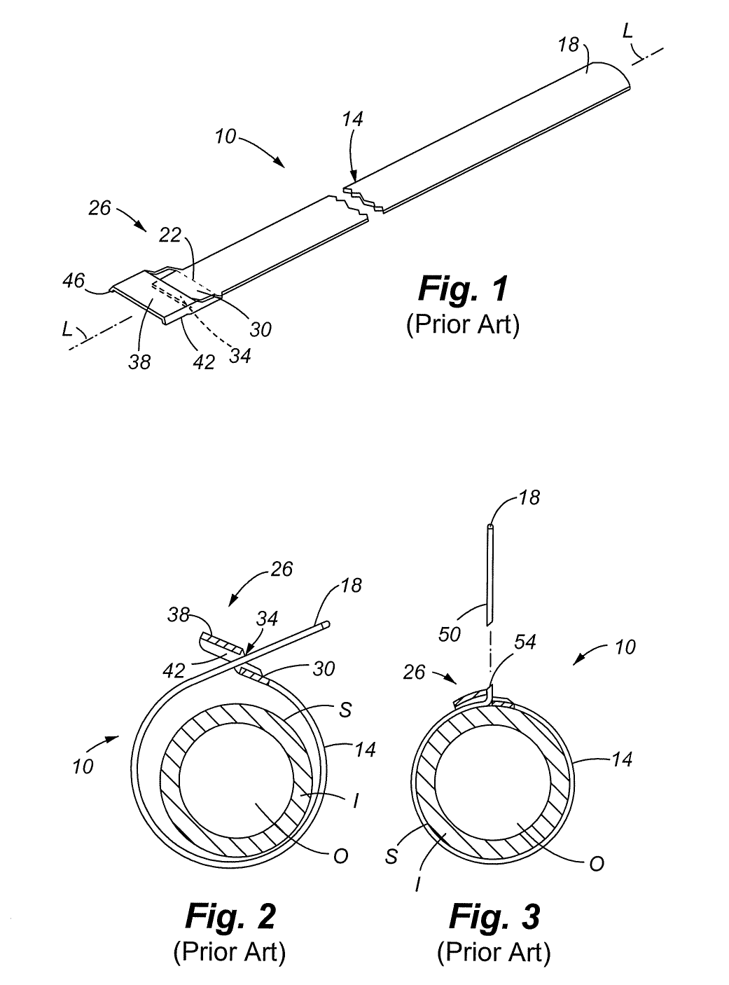

### DETAILED DESCRIPTION OF THE INVENTION

The present invention is directed to providing a protective guard for a clamping device wherein the clamping device includes a band that is wrapped around one or more objects and then cut or otherwise severed to leave a cut end. Embodiments of the protective guard provide for physically separating the cut end from an object or body part that may come in contact with the cut end.

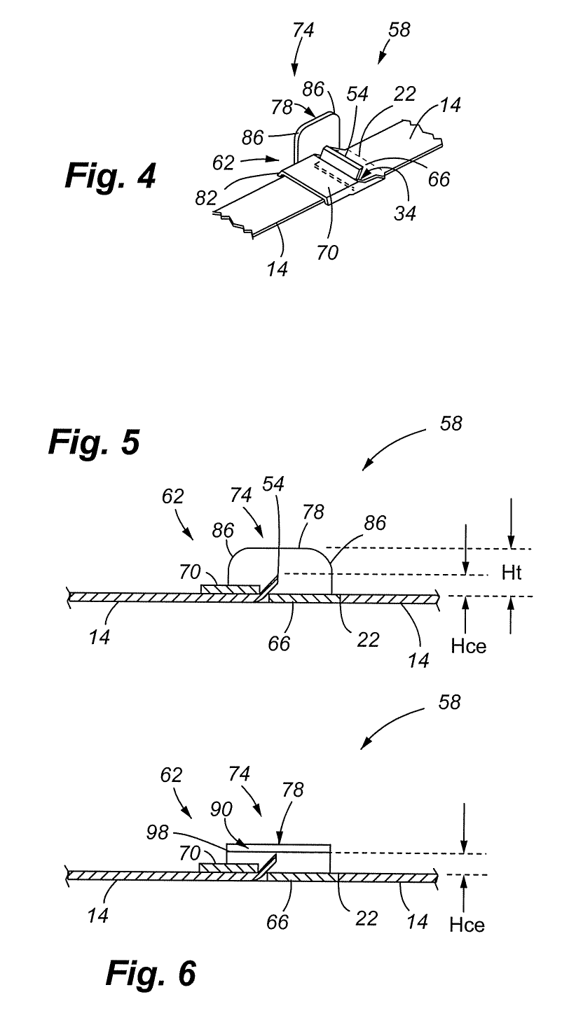

Referring now to FIGS. 4 and 5, a clamping device 58 in accordance with an embodiment of the present invention is shown. The clamping device 58 includes a band 14 and buckle 62, wherein band 14 has been pulled through the slot 34 of the buckle 62 and cut or otherwise separated to leave a terminus or cut end 54. The buckle 62 comprises a first buckle section 66 coplanar with the band 14, and a section buckle section 70 offset from the first buckle section 66. In addition, a protective guard or shield 74 is operatively associated with the buckle 62. For the embodiment shown in FIGS. 4 and 5, the shield 74 comprises a first tab 78 that is substantially parallel to first longitudinal side 82 of the buckle 62. The first tab 78 may be integral with or connected to the first longitudinal side 82 of the buckle 62. The first tab 78 preferably comprises rounded features or surfaces 86 and comprises a tab height Ht that is greater, as measured from the band 14 at the second end 22 of band 14, than a cut end height Hce as also measured from the second end 22 of the band 14.

In use, the band 14 is wrapped around the object or objects to be clamped, and then the band 14 is then pulled taut. The first end 18 of the band 14 is then cut or otherwise separated, such as along a score, from the wrapped portion of the band 14 to leave a terminus or cut end 54. The first tab 78 provides a protective guard adjacent the cut end 54.

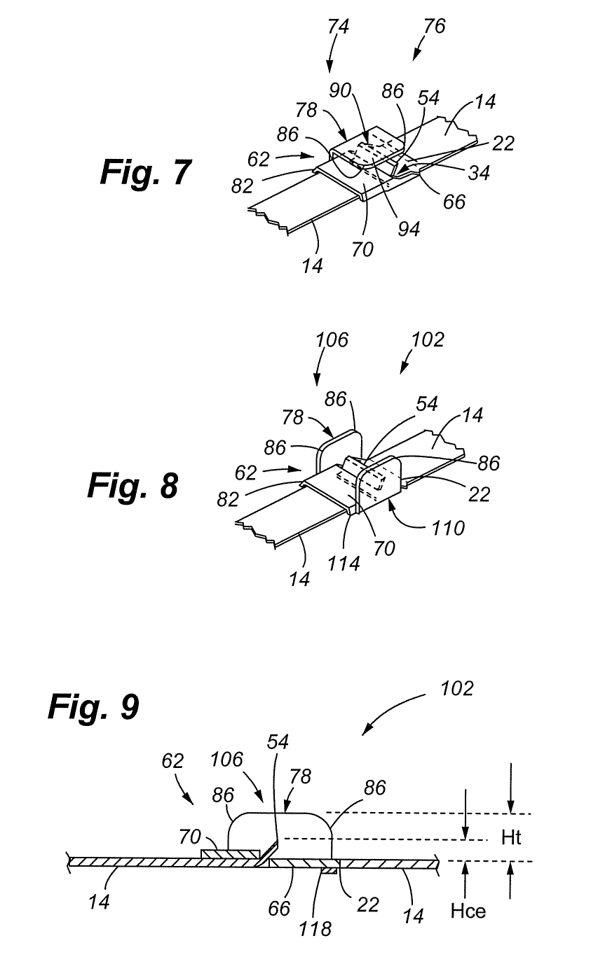

Referring now to FIGS. 6 and 7, a modified version of the clamping device of FIG. 4 is provided, wherein clamping device 76 includes a first tab 78 comprising a folded portion 90. The folded portion 90 preferably covers at least a portion of the cut end 54 of the band 14. In accordance with embodiments of the present invention, the folded portion 90 comprises an extension 94 folded along fold line 98 of first tab 78. Although not required, the fold line 98 may be scored or include cut out sections (not shown) to facilitate folding of the fold portion 90 after the band 14 is pulled taut and cut to leave cut end 54. In use, the band 14 is wrapped around the object or objects to be clamped, and then the band 14 is then pulled taut. The first end 18 of the band 14 is then cut or otherwise separated, such as along a score, from the wrapped portion of the band 14 to leave a terminus or cut end 54. The extension 94 is then folded such that at least a portion of the extension 94 provides a protective guard from a person's hand, other body part, and/or object from contacting the cut end 54.

For the clamping devices 58 and 76 shown in FIGS. 4-7, the band 14 and buckle are sized for a single wrapping around the subject object. However, the band 14 may be longer and the slot 34 larger to accommodate wrapping the band 14 around the object more than once. Therefore, it is to be understood that the shields of the present invention are applicable to guarding the cut end 54, whether the band 14 is wound one or more times around the object to which it is attached.

Referring now to FIGS. 8 and 9, a clamping device 102 in accordance with an embodiment of the present invention is shown. The clamping device 102 includes a band 14 and buckle 62 with shield 106, wherein band 14 has been wrapped around one or more objects and pulled through the slot 34 of the buckle 62 and cut or otherwise separated to leave cut end 54. Again, it is to be understood that the shields of the present invention are applicable to guarding the cut end 54, whether the band 14 is wound one or more times around the object to which it is attached. Thus, while the embodiment of clamping device 102 shown in FIGS. 8 and 9 illustrates that the band 14 is wound around the object once, those skilled in the art will appreciate that the shield 106 may also be used in a clamping device wherein the band is wrapped around the object or objects to be clamped more than once.

The buckle 62 comprises a first buckle section 66 coplanar with the band 14, and a second buckle section 70 offset from the first buckle section 66 at slot 34, where the slot 34 is sized to accommodate the thickness of band 14 in an angled orientation. If the band 14 is wrapped twice around the object, then the slot 34 is sized to accommodate two thicknesses of band 14 in an angled orientation. In addition, the protective guard or shield 106 is operatively associated with the buckle 62. For the embodiment shown in FIG. 8, the shield 106 comprises a first tab 78 that is substantially parallel to a first longitudinal side 82 of the buckle 62, and a second tab 110 that is substantially parallel to a second longitudinal side 114 of buckle 62. As with the first tab 78, the second tab 110 may be integral with or connected to the second longitudinal side 114 of the buckle 62. In addition, or in the alternative, the tabs 78 and 110 of shield 106 may be interconnected by one or more transverse members 118. The second tab 110 is similar in characteristics to the first tab 78, and preferably includes rounded features or surfaces 86 and a tab height Ht that is greater than the cut end height Hce. In use, the band 14 is wrapped around the object or objects to be clamped, and then the band 14 is pulled taut. The first end 18 of the band 14 is then cut or otherwise separated, such as along a score, from the wrapped portion of the band 14 to leave a terminus or cut end 54. The first tab 78 and second tab 110 provide a protective guard for the cut end 54 residing between the two tabs 78, 110.

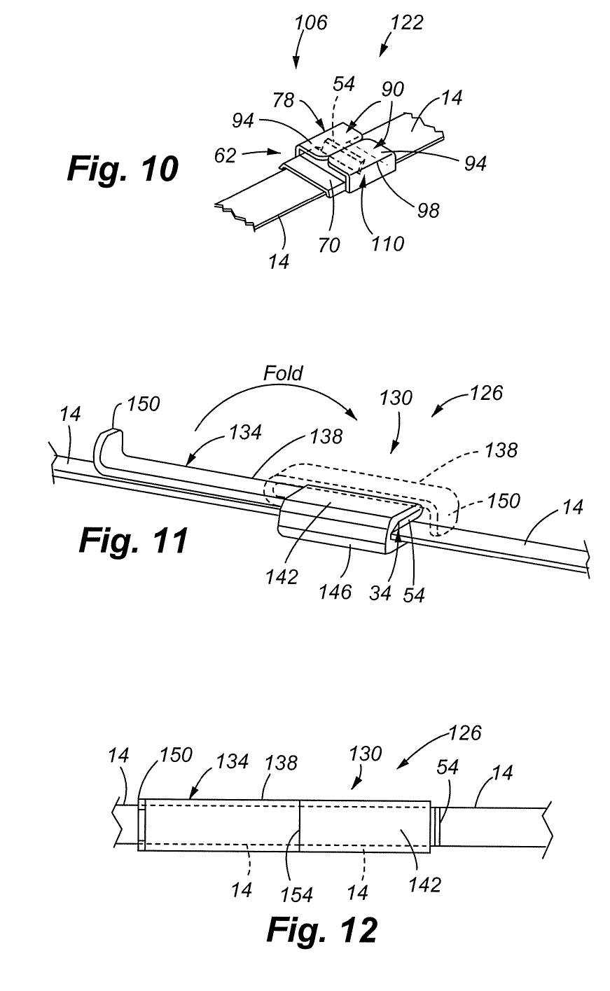

Referring now to FIG. 10, a modified version of the clamping device of FIGS. 8 and 9 is shown, wherein at least one of the first tab 78 or second tab 110 comprises a folded portion 90. For the clamping device 122 of FIG. 10, first tab 78 includes a folded portion 90. Alternatively, the second tab 110 may comprise a folded portion 90. Furthermore, for clamping device 122 shown in FIG. 10, both first tab 78 and second tab 110 may comprise folded portions 90, wherein at least one of the folded portions 90 preferably covers at least a portion of the cut end 54 of the band 14. In accordance with embodiments of the present invention, the folded portion 90 comprises an extension 94 folded along fold line 98 of first tab 78 and/or second tab 110. Although not required, the fold line 98 may be scored or include cut out sections (not shown) to facilitate folding of the fold portion 90 after the band 14 is pulled taut and cut to leave cut end 54. In use, the band 14 is wrapped around the object or objects to be clamped, and then the band 14 is then pulled taut. The first end 18 of the band 14 is then cut or otherwise separated, such as along a score, from the wrapped portion of the band 14 to leave a terminus or cut end 54. The extension 94 of either the first tab 78 and/or second tab 110, as may be applicable, is then folded such that at least a portion of the extension 94 provides a protective guard from a person's hand, other body part, and/or object from contacting the cut end 54.

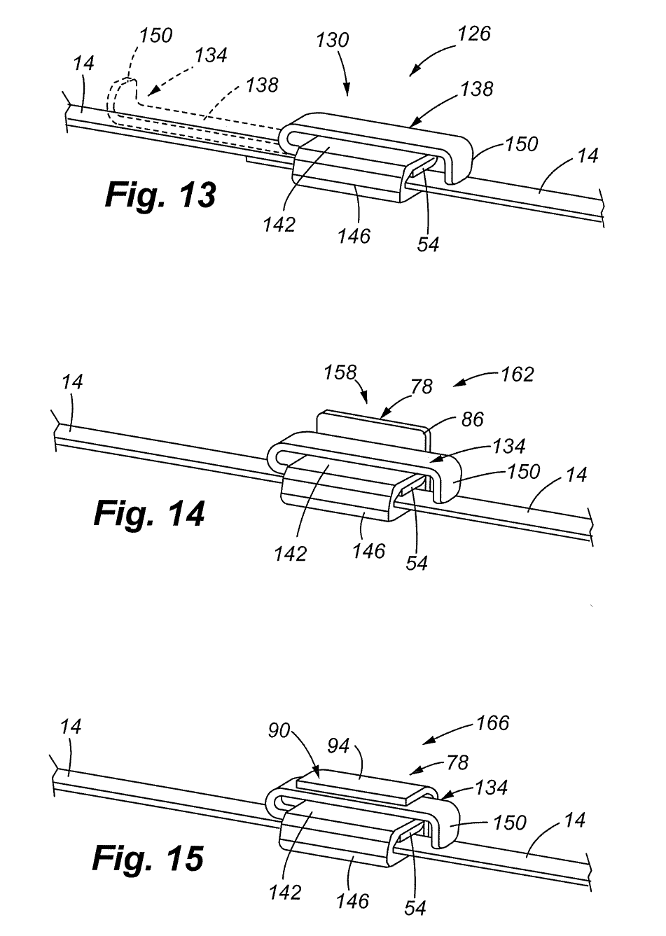

Referring now to FIGS. 11-13, another embodiment of the present invention is shown comprising clamping device 126 that utilizes a shield 130 that comprises a tab 134 having an extension portion 138, wherein at least a portion of the extension portion 138 is foldable over the terminus or cut end 54 of the band 14. For the embodiment shown in FIGS. 11-13, the extension portion 138 is coplanar with the second buckle section 142 that is separated from first buckle section 146 by slot 34. The extension portion 138 is sized for covering at least a portion of the cut end 54 when the extension portion 138 of the tab 134 is folded over the second buckle section 142. The extension portion 138 optionally includes a curved end 150 for further deflecting objects that approach the cut end 54.

In use, the band 14 is wrapped around the object or objects to be clamped, and then the band 14 is then pulled taut. The first end 18 of the band 14 is then cut or otherwise separated, such as along a score, from the wrapped portion of the band 14 to leave a terminus or cut end 54. The tab 134 is then folded, such as along fold line 154, such that at least a portion of the extension portion 138 provides a protective guard from a person's hand, other body part, and/or object from contacting the cut end 54.

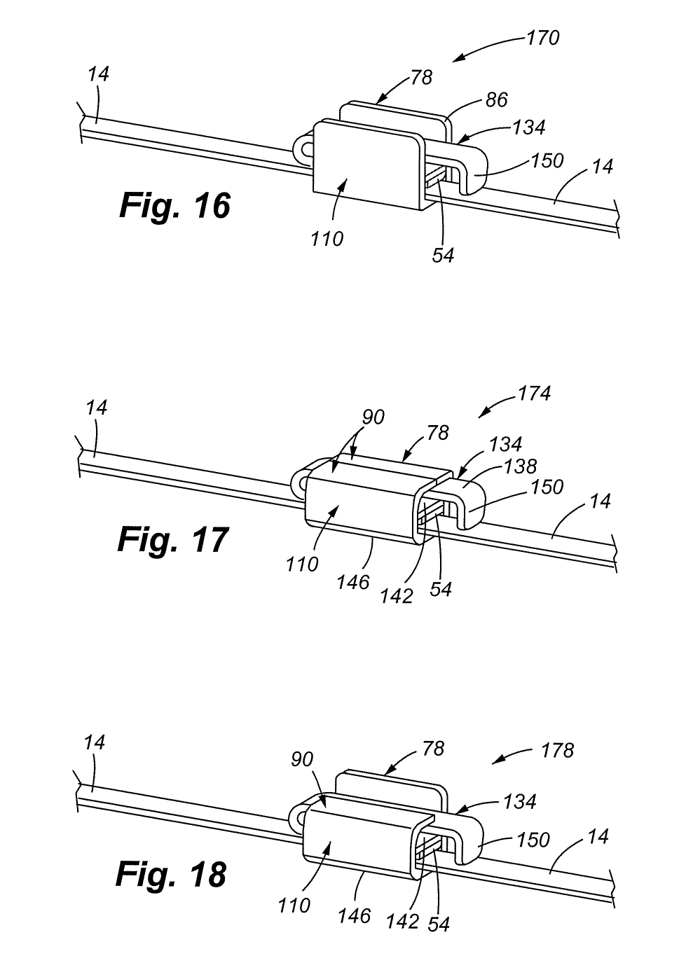

Referring now to FIGS. 14-18, a number of possible combinations of the tabs described above are illustrated. Thus, in an embodiment of the present invention shown in FIG. 14, the shield 158 of clamping device 162 includes tab 134 and tab 78, wherein the tab 134 is folded over the cut end 54 and un-folded tab 78 is located adjacent the cut end 54. In FIG. 15, clamping device 166 illustrates tab 134 and tab 78, where an extension 94 of the tab 78 has been folded such that folded portion 90 extends over the cut end 54. FIG. 16 illustrates clamping device 170 wherein the tab 134 is combined with tabs 78 and 110, wherein both tabs 78 and 110 are substantially planar and are not folded. FIG. 17 illustrates a modified version of device shown in FIG. 16, wherein the clamping device 174 of FIG. 17 comprises folded tabs 134, 78 and 110. FIG. 18 illustrates clamping device 178 wherein tab 134 is folded and only one of tabs 78 and 110 are folded to provide a protective guard for cut 54. Thus, as can be appreciated by one skilled in the art, a variety of protective configurations for the terminus or cut end 54 is possible, and all such possible combinations are within the scope of the invention.

As those skilled in the art will appreciate, the shields of the various embodiments of the present invention may be made integral with the buckles of the clamping devices, or they may be separately added and cooperate with the buckles. Whether integral with or added to the buckles, the shields are operatively associated with the buckles to provide a protective feature for the cut end 54 of the band 14.

A number of variations and modifications of the invention can be used. For example, in one alternative embodiment, the tab 134 that rotates from a back portion of the buckle to the front portion of the buckle could include side panels to further isolate the cut end 54. In another alternative embodiment, when more than one tab is used, such tabs may include a way of latching together for those embodiments where the tabs fold over one another. In still other possible variations, it would be possible to provide for some features of the invention without providing others. The foregoing variations are within the scope of the present invention.

The present invention, in various embodiments, includes components, methods, processes, systems and/or apparatus substantially as depicted and described herein, including various embodiments, subcombinations, and subsets thereof. Those of skill in the art will understand how to make and use the present invention after understanding the present disclosure. The present invention, in various embodiments, includes providing devices and processes in the absence of items not depicted and/or described herein or in various embodiments hereof, including in the absence of such items as may have been used in previous devices or processes, e.g., for improving performance, achieving ease and/or reducing cost of implementation.

The foregoing discussion of the invention has been presented for purposes of illustration and description. The foregoing is not intended to limit the invention to the form or forms disclosed herein. In the foregoing Detailed Description of the Invention for example, various features of the invention are grouped together in one or more embodiments for the purpose of streamlining the disclosure. This method of disclosure is not to be interpreted as reflecting an intention that the claimed invention requires more features than are expressly recited in each claim. Rather, as the following claims reflect, inventive aspects lie in less than all features of a single foregoing disclosed embodiment. Thus, the following claims are hereby incorporated into this Detailed Description of the Invention, with each claim standing on its own as a separate preferred embodiment of the invention.

Moreover though the description of the invention has included description of one or more embodiments and certain variations and modifications, other variations and modifications are within the scope of the invention, e.g., as may be within the skill and knowledge of those in the art, after understanding the present disclosure. It is intended to obtain rights that include alternative embodiments to the extent permitted, including alternate, interchangeable and/or equivalent structures, functions, ranges or steps to those claimed.

What is claimed is:

1. A clamping device adapted to be secured around at least one object, comprising:
a band comprising first and second ends, the band having a band length greater than a band width, the band length oriented along a longitudinal axis of the band;
a buckle operatively associated with the second end of the band for accepting the first end of the band to form a closed loop about the object; and
a shield operatively associated with the buckle;
wherein the band includes a severable portion that is removable upon forming the closed loop around the object, wherein a terminus of the band remains in the vicinity of the buckle after removal of the severable portion of the band, and wherein the shield inhibits contact with at least a portion of the terminus.

2. The clamping device of claim 1, wherein the shield comprises at least a first tab.

3. The clamping device of claim 2, wherein the shield further comprises a second tab substantially parallel to the first tab, wherein the terminus is located between the first tab and the second tab.

4. The clamping device of claim 2, wherein the first tab comprises a first foldable tab portion sized for covering at least a portion of the terminus when moved from a first non-folded position to a second folded position.

5. The clamping device of claim 4, further comprising a second tab comprising a second foldable tab portion.

6. The clamping device of claim 4, wherein the first foldable tab portion comprises an extension portion located adjacent a fold line.

7. The clamping device of claim 6, wherein the extension portion wherein the fold line is transverse to the longitudinal axis of the band.

8. The clamping device of claim 6, wherein the fold line is scored or includes cut outs to facilitate bending of the extension portion.

9. The clamping device of claim 6, wherein the extension portion is formed integrally with the buckle.

10. The clamping device of claim 6, wherein the extension portion is attached to the buckle.

11. The clamping device of claim 6, wherein the buckle comprises opposing first and second ends located transverse to the longitudinal axis of the band, and opposing third and fourth ends located parallel to the longitudinal axis of the band, and wherein the extension portion is connected to one of the opposing third and fourth ends of the buckle.

12. The clamping device of claim 11, further comprising a second tab connected to the first end of the buckle.

13. The clamping device of claim 12, wherein at least a portion of the second tab is foldable.

14. The clamping device of claim 12, further comprising a third tab connected to the second end of the buckle.

15. The clamping device of claim 14, wherein at least a portion of at least one of the second tab and the third tab is foldable.

16. A clamping device for engaging one or more objects, comprising:
means for wrapping the one or more objects, the means for wrapping including a severable portion;
means for securing a first portion of the means for wrapping to a second portion of the means for wrapping, said means for securing connected to said means for wrapping; and
means for shielding operatively associated with the means for securing, wherein the means for shielding provides a protective guard over a terminus of the means for wrapping upon removal of the severable portion.

17. The clamping device of claim 16, wherein the means for shielding comprises at least a first tab.

18. The clamping device of claim 17, wherein the means for shielding further comprises a second tab substantially parallel to the first tab, wherein the terminus is located between the first tab and the second tab.

19. The clamping device of claim 17, wherein the first tab comprises a first foldable tab portion sized for covering at least a portion of the terminus when moved from a first non-folded position to a second folded position.

20. The clamping device of claim 19, wherein the first foldable tab portion comprises an extension portion located adjacent a fold line.

21. The clamping device of claim 20, wherein the means for securing comprises opposing first and second ends located transverse to a longitudinal axis of the means for wrapping, and opposing third and fourth ends located parallel to the longitudinal axis of the means for wrapping, and wherein the extension portion is connected to one of the opposing third and fourth ends of the means for securing.

22. The clamping device of claim 21, further comprising a second tab connected to the first end of the means for securing.

23. The clamping device of claim 22, further comprising a third tab connected to the second end of the means for securing.

24. The clamping device of claim 23, wherein at least a portion of at least one of the second tab and the third tab is foldable.

25. A method of securing a clamping device around at least one object, the method comprising:
placing a band around the object;
engaging a first end of the band with a buckle to cause the band to form a closed loop around the object;
tightening the band around the object;
removing an excess portion of the band, wherein after said removing step a terminus of the band remains proximate the buckle; and
moving at least a portion of a shield from a first position to a second position so as to cover at least a portion of the terminus.

26. The method of claim 25, wherein said moving step comprises folding at least a first foldable tab of the shield along a fold line.

27. The method of claim 26, wherein said moving step comprises folding at least a second foldable tab of the shield along a fold line.

28. In subcombination, a protective guard for use with a clamping device, the clamping device including a band adapted for wrapping around at least one object, the clamping device further including a buckle for securing a first portion of the band with a second portion of the band, wherein the second portion of the band comprises a cut end, the protective guard comprising:
at least a first tab extending from the buckle, wherein the first tab is located proximate the cut end, and wherein at least a portion of the first tab is moveable from a first position to a second position to cover at least a portion of said cut end.

29. The subcombination as claimed in claim 28, wherein said first tab resides adjacent a fold line.

30. The subcombination as claimed in claim 28, wherein at least a second tab extends from the buckle, and wherein the second tab is located proximate the cut end.
